(19) United States
(12) Patent Application Publication
(10) Pub. No.: US 2022/0250272 A1
(43) Pub. Date: Aug. 11, 2022

(54) AUTOMATIC CHAINSAW CHAIN TENSION ADJUSTER

(71) Applicant: John Wilson, Rancho Santa Fe, CA (US)

(72) Inventor: John Wilson, Rancho Santa Fe, CA (US)

(21) Appl. No.: 17/337,609

(22) Filed: Jun. 3, 2021

Related U.S. Application Data
(60) Provisional application No. 63/147,598, filed on Feb. 9, 2021.
(60) Provisional application No. 63/148,107, filed on Feb. 10, 2021.

(51) Int. Cl. B27B 17/14; B27B 17/02

(52) U.S. Cl. CPC B27B 17/14; B27B 17/02

(57) ABSTRACT

An automatic chainsaw chain tension adjuster is provided. The automatic chainsaw chain tension adjuster maintains the chain of a chainsaw on the chainsaw guide bar during use. As heat expands the overall length of the chain while the chainsaw is running, an internal spring forces a sprocket located at the second end of the guide bar outward therein increasing the overall path the chain must travel around the guide bar/sprocket to compensate for the heat expansion. As the chain of the chainsaw heats up or cools down during use and non-use, the internal spring automatically adjusts the chain to the exact proper tension.

### CROSS REFERENCE TO RELATED APPLICATIONS

The following application is a based on and claims the priority benefit of U.S. provisional application Ser. No. 63/147,598 filed on Feb. 9, 2021 and 63/148,107 filed on Feb. 10, 2021, both currently co-pending; the entire content of which is incorporated by reference.

### BACKGROUND OF THE INVENTION

A chainsaw is a power tool that may be used to cut quickly through tree trunks, branches and so on. A chainsaw may be gas or electric. One of the most inconvenient problems with a chainsaw is that during the cutting operation the chain may expand due to the heat generated by the friction between the chain and the chain guide bar. The chain may therefore increase in overall length therein causing a loss of the preset tension of the chain. When this occurs, the chain may fall off from the chain guide bar. This may cause a lot of accidents, and may take a lot time to repair.

The present device will eliminate these inconveniences, making the chainsaw operation safer, the cutting operation much smoother, and may save time by reducing required maintenance of the chainsaw. Further, the present device may not require any additional tools to operate.

An automatic chainsaw chain tension adjuster is provided. The automatic chainsaw chain tension adjuster maintains the chain of a chainsaw on the chainsaw guide bar during use of the chainsaw. As heat expands the overall length of the chain while the chainsaw is running, an internal spring forces a sprocket located at the second end of the guide bar outward therein increasing the overall path the chain must travel around the guide bar/sprocket to compensate for the heat expansion of the chain. As the chain of the chainsaw heats up or cools down during use and non-use, the internal spring automatically adjusts the chain to the exact proper tension so that the chain does not fall off the guide bar.

The present device keeps the chainsaw chain cutting at the same preset tension during the entire operation of the chainsaw. Further, the present device also meets the common “snap test” for chainsaws. The constant proper tension the present device applies to the chain is achieved by the automatic adjustment of distance between the sprocket and the guide bar of the chainsaw through an internal spring assembly. The internal spring assembly increases or decreases the distance the chain must travel to compensate for the change of the length of the chain due to heat dilatation.

The present automatic chain tension adjuster device may be used in connection with many different chainsaw designs and may be used with both gas and electric chainsaws.

Prior patents fail to describe an automatic chainsaw tension adjuster which is easy to use. Further, these patents fail to provide for an automatic chainsaw tension adjuster which allows for safe and uninterrupted use of a chainsaw.

### SUMMARY OF THE INVENTION

The present automatic chainsaw chain tension adjuster continuously adjusts the distance between the driving sprocket and the fixed chainsaw guide bar. The distance between those two elements is controlled by an internal spring drive mechanism device which compensates for the increased length of the chain due to heat dilation. As a result, the chain remains on the guide bar during use.

An automatic chainsaw chain tension adjuster is provided. The automatic chainsaw chain tension adjuster maintains the chain of a chainsaw on the chainsaw guide bar during use of the chainsaw. As heat expands the overall length of the chain while the chainsaw is running, an internal spring forces a sprocket located at the second end of the guide bar outward therein increasing the overall path the chain must travel around the guide bar/sprocket to compensate for the heat expansion of the chain. As the chain of the chainsaw heats up or cools down during use and non-use, the internal spring automatically adjusts the chain to the exact proper tension so that the chain does not fall off the guide bar.

An automatic chainsaw tension adjuster is provided. The automatic chainsaw tension adjuster has an internal spring connected to the sprocket which automatically adjusts the tension on a chainsaw chain to exactly compensate for the chains dilation and therefore loosening which is caused by the increased heat created during use of the chainsaw. The internal spring moves the sprocket of the housing of the chainsaw away from the guide bar of the chain (in one embodiment) to increases the tension of the chain which would be otherwise relaxed from the expansion of the chain caused by the frictional heat created during operation. As a result, the chain remains consistently tight and is prevented from becoming disengaged with the guide bar.

One of the biggest problems with using a chainsaw is that during use the chain quickly becomes slightly longer as a result of dilation created from the heat generated by the movement of the chain. The increased length of the chain means that the chain often becomes dislocated from the guide bar of the chainsaw and needs to be properly reattached. This can result in a safety hazard. The present device solves that problem.

By the present device, the tension of the cutting chain is adjusted so that it neither binds on nor becomes loose from the guide bar during use. In order for a chainsaw to safely and effectively cut, the chain needs to have the proper tension around the metal guide bar upon which it rides. If the chain is too tight, not only will it rob the chainsaw's engine of power due to increased friction, but the chain also runs the risk of breaking. If the chain is too loose, it can come off the guide bar and seriously injure the operator. Further, if the chain is loosened the chain may cause damage to the guide bar or other portions of the chainsaw. Replacing and mounting of the chain is very difficult, requiring technical skill and requiring specialized tools. The present device maintains a consistent tension on the chain of the chainsaw while the chainsaw is in use.

An advantage of the present automatic chainsaw tension adjuster is that the present automatic chainsaw tension adjuster saves time by not requiring someone to reattach a chain to the guide bar of the chainsaw which may be caused by the chain falling off the guide bar of the chainsaw from expansion of the length of the chain during use.

And another advantage of the present automatic chainsaw tension adjuster is that the present automatic chainsaw tension adjuster has an internal spring which provides consistent tension on the chain of the chainsaw during use during heating up and cooling down of the chainsaw.

Still another advantage of the present automatic chainsaw tension adjuster is that the present automatic chainsaw tension adjuster has an internal spring mechanism which acts as a shock absorber to absorb vibrational forces that the chain of the chainsaw encounters during use, therein making the chainsaw operate more smoothly.

Yet another advantage of the present automatic chainsaw tension adjuster is that the present automatic chainsaw tension adjuster may be used in connection with gas or electric chainsaws.

And yet another advantage of the present automatic chainsaw tension adjuster is that the present automatic chainsaw tension adjuster extends the life of the guide bar and chainsaw by reducing the wear and tear of the chain guide bar which is caused by extended vibration of the chain over time.

Still another advantage of the present automatic chainsaw saw tension adjuster is that a user never needs to remove the chain bar from the chainsaw for maintenance.

Still another advantage of the present automatic chainsaw saw tension adjuster is that the chain guide bar is permanently bolted in the body of chainsaw.

Still another advantage of the present automatic chainsaw saw tension adjuster is that because the chain guide bar is permanently bolted to the body of chainsaw, the chain guide bar never becomes loosed during cutting operation.

Yet another advantage of the present automatic chainsaw saw tension adjuster is that the present device increases the safety operation of the chainsaw by eliminating accidents that typically are caused by the chain falling off of standard chainsaws.

Still another advantage of the present automatic chainsaw saw tension adjuster is that a user does not need tools to remove and replace the chain from the chainsaw for maintenance.

Another advantage of the present automatic chainsaw saw tension adjuster is that a user never needs to remove the chain bar from the chainsaw for maintenance.

For a more complete understanding of the above listed features and advantages of the automatic chainsaw tension adjuster reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a perspective view of a chainsaw.

FIG. 2 illustrates a side view of the chainsaw with the protective cover removed so that the entire chain may be seen.

FIG. 3 is a detailed view of the sprocket and the second end of the guide bar wherein the internal spring mechanism is illustrated.

FIG. 4 is an alternative embodiment of the sprocket and the second end of the guide bar wherein the internal spring mechanism is illustrated. In this embodiment, the orientation of the spring is reversed and the spring pulls, instead of pushes, the sprocket away from the guide bar.

FIG. 5 illustrates a quick release level of the chainsaw in one embodiment wherein the quick release level is in the first position.

FIG. 6 illustrates a quick release level of the chainsaw in one embodiment wherein the quick release level is in the second position.

FIG. 7 illustrates the length of the chain when the chainsaw is not moving or is moving slow.

FIG. 8 is an exaggerated view of the length of the chain expansion during use when the chain is heated up from the frictional heat and further shows the increased distance between the sprocket and the second end of the guide bar which is achieved by the internal spring forcing the sprocket away from the guide bar.

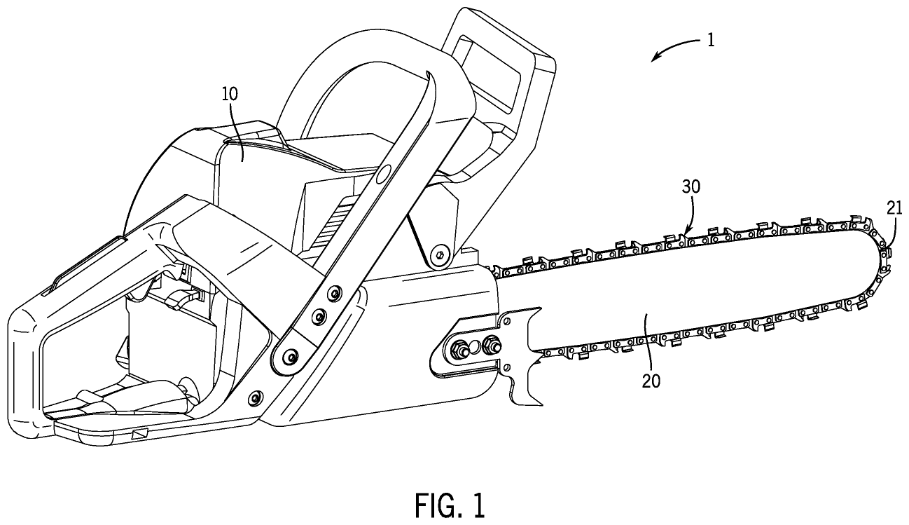

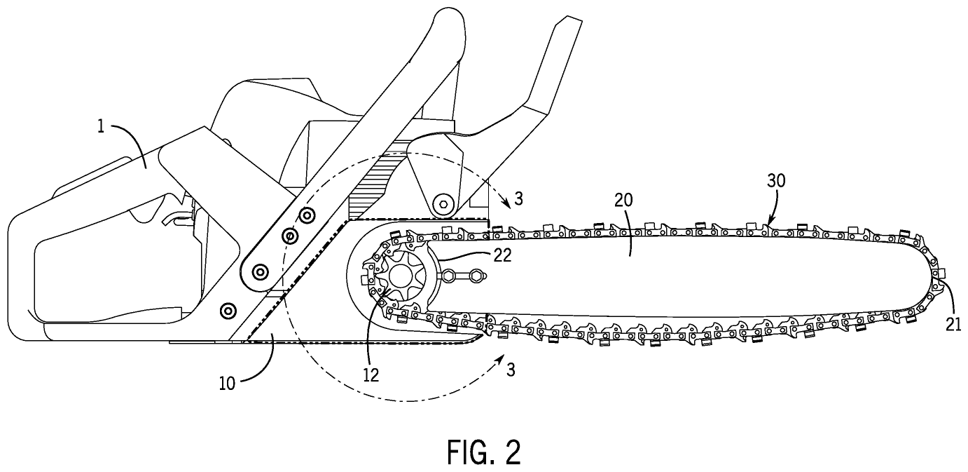

### DETAILED DESCRIPTION OF THE PREFERRED EMBODIMENTS

An automatic chainsaw chain tension adjuster is provided. The automatic chainsaw chain tension adjuster maintains the chain of a chainsaw on the chainsaw guide bar during use of the chainsaw. As heat expands the overall length of the chain while the chainsaw is running, an internal spring forces a sprocket located at the second end of the guide bar outward therein increasing the overall path the chain must travel around the guide bar/sprocket to compensate for the heat expansion of the chain. As the chain of the chainsaw heats up or cools down during use and non-use, the internal spring automatically adjusts the chain to the exact proper tension so that the chain does not fall off the guide bar.

An automatic chainsaw tension adjuster is provided. The automatic chainsaw tension adjuster has an internal spring connected to the sprocket which automatically increases the tension on a chainsaw chain to exactly compensate for the chains dilation and therefore loosening which is caused by the increased heat created during use of the chainsaw. The internal spring pulls the sprocket of the housing of the chainsaw away from the guide bar of the chain to increases the tension of the chain which would be otherwise relaxed from the expansion of the chain caused by the frictional heat created during operation. As a result, the chain remains consistently tight and is prevented from becoming disengaged with the guide bar.

Referring now to the figures, in an embodiment a chainsaw 1 is provided. The chainsaw 1 may have a main housing 10. The main housing 10 may have an internal motor (not illustrated) which is mechanically secured to a movable sprocket 12 which rotates three hundred and sixty degrees around a pin 13. A guide bar 20 having a first end 21 and a second end 22 may be connected to the housing 10 may act as a rail for a cutting chain 30. The first end 21 of the guide bar 20 may be rounded (such as semi-circular) while the second end 22 of the guide bar 20 may have a concave arch 23. The guide bar 20 may have a slight internal groove at its permitter wherein groove receives a portion of the chain 30 and keeps the chain 30 aligned on the guide bar 20. In an embodiment, the first end 21 of the guide bar is convex and the second end 22 is concave. In an embodiment, the arch of the concave and convex sides are substantially the same. In one embodiment, the guide bar 20 is bolted permanently to the main housing 10 of the chainsaw 1 and, therefore, never becomes loosened during use of the chainsaw 1.

The movable sprocket 12 may be located at or near the second end 22 of the guide bar 20. The movable sprocket 12 may have a plurality of teeth 14 which rotate around the circular pin 13. An adjustable space 15 may be located between the arch 23 of the second end 22 of the guide bar 20 and (an internal second base 70) of the sprocket 12. The chain 30 is forced to rotate around both the teeth 14 of the sprocket 12 and the top, the bottom and first end 21 of the guide bar 20 as a result of the motor quickly rotating the sprocket 12. The rotation of the chain 30 therein is used for cutting an object.

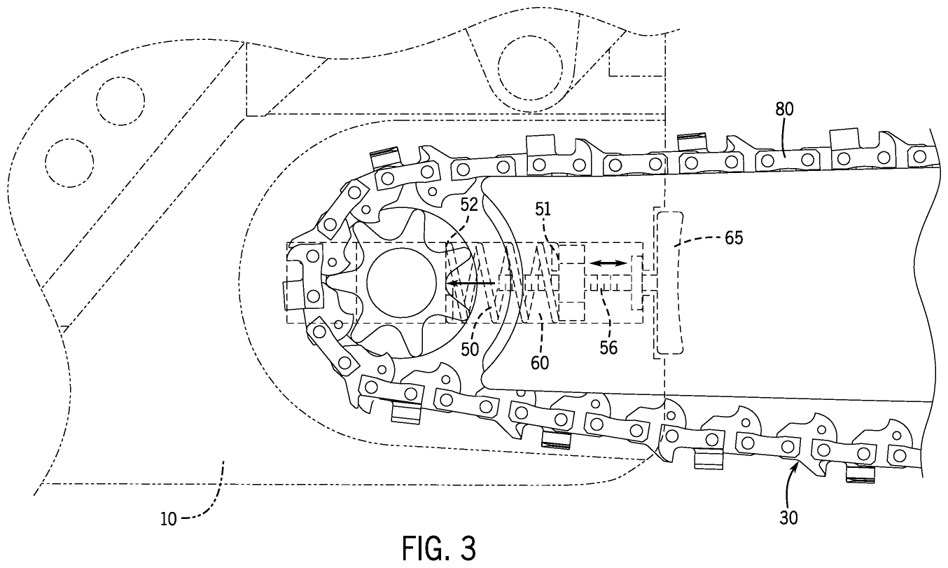

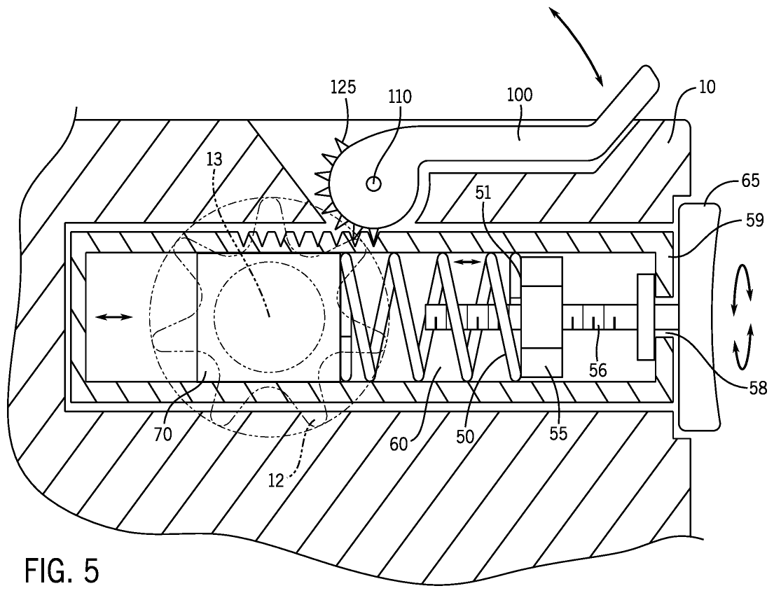

Referring now to FIGS. 3-5, in an embodiment, an internal spring 50 having a first end 51 and a second end 52 may be present within an interior cylindrical hollow tube 60 (or “channel”) located within the interior of the housing 10 of the chainsaw 1. The first end 51 of the internal spring 50 may be secured to a first base unit 55 (FIG. 5) which is attached to a rod 56. The rod 56 passes through an opening 58 at an end 59 of the interior cylindrical hollow tube 60. The portion of the rod 56 which extends outside of the interior cylindrical hollow tube 60 is connected to a rotating knob 65. The rotating knob 65 is accessible outside the housing 10 of the chainsaw 1 and allows a user to adjust the tension of the internal spring 50 by rotating the rotating knob 65 clockwise or counter-clockwise to compress or expand the internal spring 50 depending on the desired setting. In an alternative embodiment, the first base unit 55 may simply be the terminal end 59 of the interior cylindrical hollow tube 60. In that embodiment, the spring 50 is secured directly to the terminal end 59 of the interior cylindrical hollow tube 60.

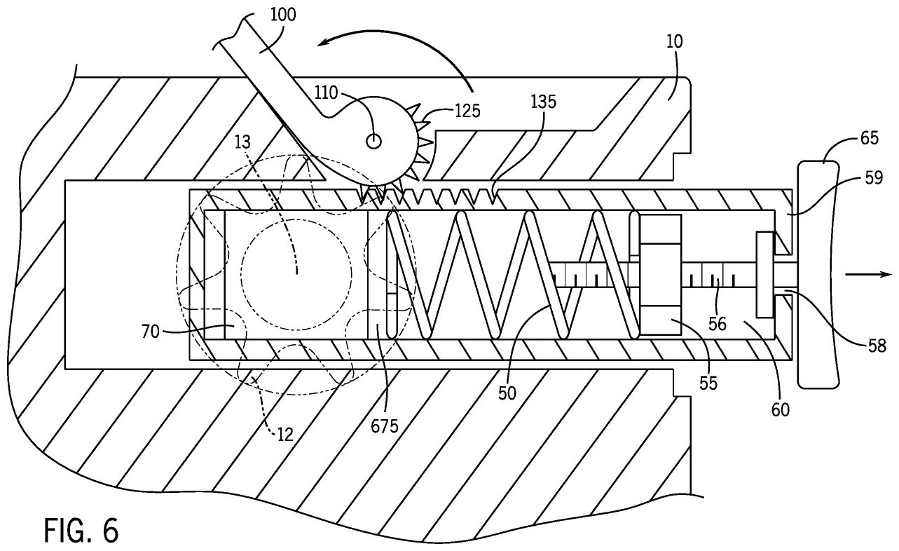

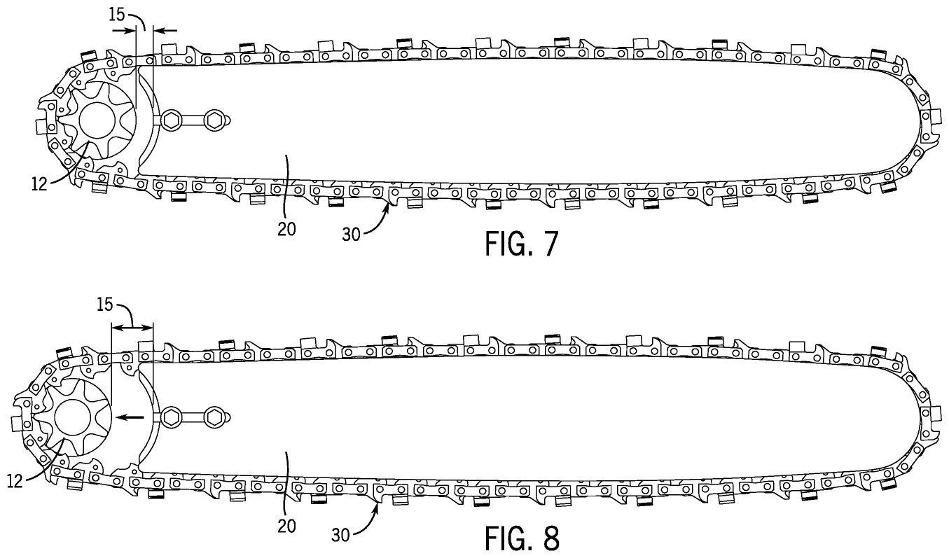

The second end 52 of the internal spring 50 is secured to (or, with the lever 100 embodiment of FIGS. 5 and 6 at least touches) a second base unit 70 located within the interior hollow tube 60. The second base unit 70 supports the pin 13 and, therefore, the sprocket 12. In particular, the second base unit 70 is located within the hollow interior channel 60 while the sprocket 12 is located outside the hollow interior channel 60. As the second base unit 70 is moved forward or backward along an x-axis within the interior hollow channel 60 the sprocket 12 therein moves accordingly.

Because the distance 15 between the sprocket 12 (or internal second base 70) and the stationary first end 21 of the guide bar 20 is altered by the movement of the second base unit 70 (and therein sprocket 12), the distance any specific individual link 80 of the chain 30 must travel is altered by the movement of the sprocket 12 forward or backward with respect to the first end 21 of the guide bar 20. More specifically, as the sprocket 12 moves closer to the arch 23 of the second end 22 of the guide bar 20, the full perimeter the chain 30 travels in completion of a full cycle is reduced. Conversely, as the distance 15 between the sprocket 12 and the arch 23 of the stationary second end 23 of the guide bar 20 is increased, the total distance the chain 30 travels in one full rotation is increased. Because the distance 15 between the sprocket 12 and the guide bar 20 is continuously adjusted by the internal spring 50 of the housing, the spring 50 may therein compensate for the dilation of the chain 30 from the frictional heat created during use of the chainsaw 1. As a result, a present tension on the chain 30 of the chainsaw 1 may be maintained during use.

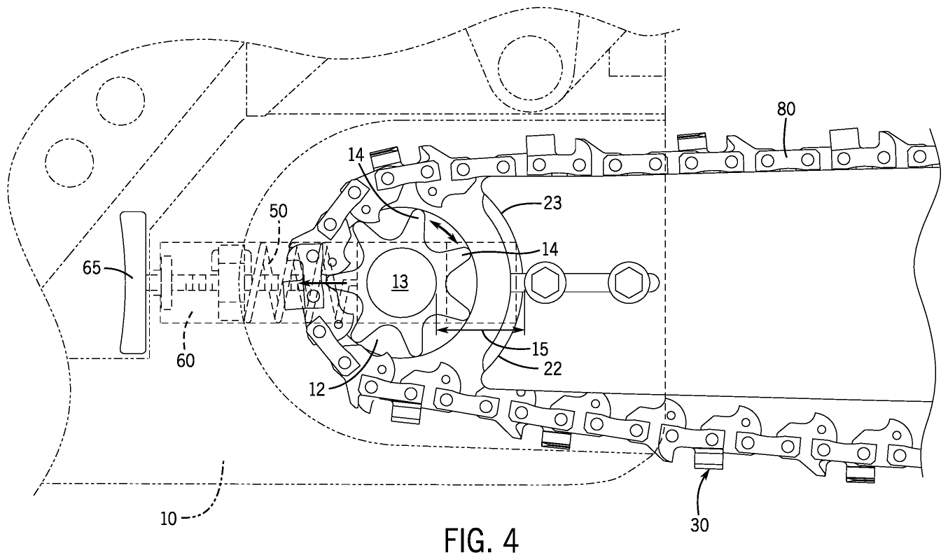

The present internal spring 50 is biased to automatically apply pressure to force the sprocket 12 away from the arch 23 of the second end 22 of the guide bar 20 so that any slack in the chain 30 caused by the frictional heat expansion during use is automatically and precisely eliminated by the spring 50. FIG. 3 illustrates one embodiment wherein the internal spring 50 is biased to force the sprocket 12 away from the arch 23 of the guide bar 20. FIG. 4 illustrates an alternative set-up applying the same principal of eliminating the slack of the chain 30 during use; however, in the FIG. 4 embodiment, the internal spring 50 is biased to pull the sprocket 12 away from the arch 23 of the guide bar 20 and is located on the opposite side of the sprocket 12.

While using a chainsaw, the frictional heat generated by the rotating chain causes the chain to expand. In standard chainsaws, the expanded length of the chain during use, combined with the non-expanded total perimeter of the guide bar, often causes the chain to become dislocated from the guide bar causing injury to the person, damage to the property or, at the least, a delay in operation of the chainsaw.

When the chain 30 is rotating at a reduce speed or even not rotating at all, the overall length of the chain 30 is decreased. Because the internal spring 50 is constantly applying the precise counter-force to either push (as in FIG. 3) or pull (as in FIG. 4) the sprocket 12 with respect to the arch 23 of the guide bar 20, the slack of the chain 30 is always eliminated with the precise amount of counter force. For example, when the chainsaw is first turned on, the chain 30 has the same temperature as the surrounding air. As the chain 30 slowly heats up and expands, the internal spring 50 slowly and precisely moves the sprocket 12 away from (or toward in FIG. 4) the arch 23 of the guide bar 20. As the chainsaw 1 is turned off, the chain 30 slowly cools and shrinks and the internal spring 50 therein applies less pressure and the sprocket 12 automatically starts to move back toward the arch 23 of the guide bar 20 without the user needing to make any adjustments. The chain 30, therefore, is prevented from accidentally falling off the guide bar 20. In an alternative embodiment (not shown), the sprocket 12 may remain stationary as the guide bar is moved slightly away from the sprocket 12, therein accomplishing the same increase of tension adjustment. Still further, in one embodiment, both the sprocket 12 and the guide bar 20 may move with respect to each other to adjust the chain 30 to the proper tension during use.

During use, frictional heat causes the rotating the chain 30 to dilate and therefore increase in overall length. The overall length means that the chain 30 can more easily fall off the guide bar 20. Having the internal spring 50 actively and automatically move the sprocket 12 either toward or away from the guide bar 20 results in an automatic and precise increase in tension to equal that increased length of the chain 30. Therefore, as the overall length any link 80 of the chain 30 must travel increases during use, at the same time, the spring 50 adjusts the sprocket 12 with respect to the guide bar 20 therein increasing the tension and exactly compensating of the increased length of the chain 30.

In one embodiment, the chainsaw 1 may be an automatic quick release lever 100 (FIGS. 5 and 6). It should be understood that the present chainsaw 1 with the internal spring 50 may lack the automatic quick release lever 100. The quick release lever 100 may be connected to the housing 10 by a pin 110 which allows the quick release lever 100 to move from a first position (as shown in FIG. 5) to a second position (as shown in FIG. 6). The quick release lever 100 may have a plurality of teeth 125. The plurality of teeth 125 of the quick release lever 100 may temporarily and adjustably lock into indentations 135 of the exterior of the interior hollow tube 60. When a user moves the quick release lever 100 to the second position of FIG. 6, the tension on the internal spring 50 is quickly released therein allowing the sprocket 12 to move closer to the arch 23 of the second end 22 of the guide bar 20. When that happens, the tension on the chain 30 is quickly eliminated. When a user moves the lever 100 into the first position of FIG. 5 the internal spring 50 is tightened and the device 1 may be used normally as described above. Therefore, the quick release lever 100 may be used to quickly release the tension on the chain 30 with respect to the guide bar 20.

As shown in FIG. 6, a space 675 is created between the send end 52 of the spring 50 and the internal second base 70 of the sprocket 12 when the lever 100 is in the second position of FIG. 6 (or the “released” position). In this position, the tension is released. When a user moves the lever 100 to the first position of FIG. 5 (the “locked” position), the space 675 is eliminated and the chainsaw 1 may be used with the automatic tension adjuster mechanism.

Another advantage of the present chainsaw is that because the sprocket 12 may be moved by the lever 100 closer to the guide bar 20, a user may release the tension on the chainsaw chain to easily replace the chain without the need for any additional tools. In particular, a user first moves the lever 100 to the relaxed position (FIG. 6) wherein the sprocket 12 is closer to the second end 22 of the guide bar 20. In this position the user may easily remove the chain from the guider bar to replace the chain without tools being required. Once the chain is replaced, the lever 100 is moved back to the secured position (FIG. 5) and the chainsaw 1 may be used again to use.

Finally, another advantage of the internal spring 50 of the present chainsaw 1 is that the spring 50 also acts as a shock absorber by helping to absorb the friction and repetitive movement and shaking of the chainsaw 1 while the chainsaw 1 is cutting an object.

The present invention may be applied to many variances and types of chainsaws.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1) A chainsaw comprising:
a housing;
a guide bar having a first end and a second end wherein the guide bar is secured to the housing;
a rotatable sprocket on the housing wherein the rotatable sprocket is located near the second end of the guide bar;
a chain wherein the chain rotates around the sprocket and a portion of the guide bar; and
wherein the sprocket moves with respect to the guide bar.

2) The chainsaw of claim 1 further comprising:
teeth located on the sprocket.

3) The chainsaw of claim 1 further comprising:
an internal channel located within the housing; and
a first base unit located within the internal channel of the housing wherein the first base unit is secured to a rod and an adjustment knob located outside of the housing.

4) The chainsaw of claim 1 further comprising:
a second base unit located within the internal channel wherein the second base unit has a pin which receives the sprocket.

5) The chainsaw of claim 4 further comprising:
a spring located within the internal channel wherein the spring has a first end and a second end and wherein the first end of the spring is connected to a first base and wherein the second end of the spring contacts and applies pressure to the second base unit.

6) The chainsaw of claim 5 wherein the spring moves the second base unit within the interior channel with respect to the guide bar to constantly adjust the tension of the chain during use.

7) The chainsaw of claim 3 further comprising:
an opening at an end of the internal channel of the housing wherein the rod passes through the opening and wherein the adjustment knob is located outside of the internal channel.

8) The chainsaw of claim 1 wherein the first end of the guide bar is convex and wherein the second end of the guide bar is concave.

9) The chainsaw of claim 1 wherein a portion of the chain is secured within a portion of the guide bar.

10) The chainsaw of claim 1 further comprising:
a lever located outside of the housing.

11) The chainsaw of claim 10 wherein the lever moves from a first position to a second position and wherein in the first position the lever moves a base unit into contact with an internal spring and wherein the base unit supports the sprocket and wherein in the second position the lever moves the base away from the internal spring.

12) The chainsaw of claim 1 wherein the distance between the sprocket and the guide bar is continuously adjusted by an internal spring of the housing in order to compensate for the dilation of the chain from frictional heat during use and to therein keep a present tension with respect to the chain.

13) The chainsaw of claim 1 wherein the guide bar is permanently secured to the housing to eliminate loosening of the guide bar during use of the chainsaw.

14) The chainsaw of claim 1 wherein the chainsaw requires no tools for maintenance.
